(19) United States
(12) Patent Application Publication
(10) Pub. No.: US 2012/0191568 A1
(43) Pub. Date: Jul. 26, 2012

(54) DRAG AND DROP PURCHASING BIN

(75) Inventor: Saumil Ashvin Gandhi, Sunnyvale, CA (US)

(73) Assignee: EBAY INC., San Jose, CA (US)

(21) Appl. No.: 13/341,559

(22) Filed: Dec. 30, 2011

Related U.S. Application Data
(60) Provisional application No. 61/435,147, filed on Jan. 21, 2011.

(51) Int. Cl. G06Q 30/06

(52) U.S. Cl. 705/26.8

(57) ABSTRACT

Methods and systems are provided that facilitate a consumer's making purchases directly from online websites to a bin on a consumer device by dragging and dropping the desired item from the online site to the bin. A user or consumer may install a plug-in, extension, or app for the bin onto the user device. The user bin may include certain properties, such as user ID (e.g., email address), password, pre-authorization conditions (e.g., maximum purchase amount per transaction), and shipping address. Once installed, the user may see a representation of the bin on the user device, or on another device such as a television screen or shopping kiosk display. A merchant online site may be adapted to enable the merchant site to interface to the bin, for example, using an application programming interface (API) or web scraping, to retrieve specific information from the merchant site.

### CROSS REFERENCE TO RELATED APPLICATIONS

This application claims priority to U.S. Provisional Application No. 61/435,147 filed on Jan. 21, 2011, which is hereby incorporated by reference.

### BACKGROUND

1. Technical Field

The present invention generally relates to facilitating electronic commerce over a network and, more particularly, to making purchases electronically.

2. Related Art

Shopping online or electronically is becoming more and more prevalent. This is due in part to the ease of which a consumer can find, pay, and complete a transaction without going to a seller's physical location. Such online shopping is predominantly done from a consumer's personal computer (PC) or laptop, and as such, payment service providers, such as PayPal Inc. of San Jose, Calif., have developed payment flows that enable the online consumer to quickly, easily, and safely make an online payment for a purchase.

In a typical transaction, the consumer locates one or more desired items from a merchant website, selects the desired item or items to place them in a shopping cart, selects a payment source, and confirms the purchase. This is all done on one or more online websites, e.g., a merchant site and possibly a payment service provider site, although most transactions are and can be done from the merchant site. As such, each transaction is typically performed with one merchant or online retailer. If the consumer wishes to make a purchase with another online seller, the consumer generally is required to then access the new online seller site and go through the purchase and payment steps for that new seller. This can be burdensome and time-consuming if the consumer wishes to purchase items from different online sellers during one session.

In addition, both consumers and online merchants may desire to have a different way of performing an online purchase. Different methods may make it easier or more fun for the consumer, resulting in more transactions or purchases by the consumer and thus higher revenue for online merchants.

### SUMMARY

Systems and methods according to one or more embodiments allow a consumer to make a purchase directly from an online site to a bin on a consumer device by dragging and dropping the desired item from the online site to the bin. A user or consumer installs a plug-in, extension, or app for the bin onto the user device. In some embodiments, server side technologies which enable drag and drop shopping may also be employed. In either case, such an application can be provided by a payment service provider, such as PayPal, Inc., of San Jose, Calif. The user bin may include certain properties, such as user ID (e.g., email address), password, pre-authorization conditions (e.g., maximum purchase amount per transaction), shipping address and merchant ID. Once installed, the user may see a representation of the bin on the user's device, such as on the desktop or home screen. A merchant online site may also be adapted to enable the merchant site to be accessed via a desktop application, such as using screen scraping to retrieve specific information from the merchant site, e.g., merchant ID, product ID, or shipping cost.

Once installed, the user may make a purchase by first accessing the merchant site through a device browser. A list of items may appear on a merchant page. The user then may drag and drop one or more desired items from the web page to the bin; the bin may be detached from the webpage and may be displayed on the user device or another device. “Dragging and dropping” can be performed in a number of ways that select and move an item. If the selected item requires additional attributes or information, such as size or color, the user may be asked to enter such information, such as through the user device or through the properties of the transaction bin or through information retrieved from the URL (uniform resource locater) or the source of the website where the item resides. The “dropped” item is then processed through the bin, and if approved, the transaction may be completed. The user may be given an option to finish the transaction or continue shopping. If finished, the bin may output a receipt for the transaction. If the user wishes to continue shopping, the user may drop additional items from the merchant site or drop items from one or more different merchant sites.

As a result, the user is provided with a unique shopping experience from a user device that gives the user a “feel” of actually placing physical goods into a bin for purchase. The purchase can then be made with little or no additional input from the user. The user may also be able to make such bin transactions across different online sites in a single purchase and through a single bin.

In one embodiment, a system includes a processor and a computer-readable medium having computer readable code for instructing the processor to perform a method, the method including: receiving transaction information from a user, wherein the information is received in response to the user moving, using a user device, an item displayed on a screen to a bin; determining item information from the transaction information; determining user information from the bin; and processing the electronic transaction using the transaction information, the item information, and the user information.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 is a system block diagram of is a system diagram illustrating a system for conducting electronic transactions using a mobile device over a network, in accordance with one or more embodiments;

FIG. 2 is a graphical illustration of a user interface for electronic transactions using a bin (bin transactions) in accordance with one or more embodiments;

FIGS. 3A, 3B, and 3C are graphical illustrations of alternative user interfaces for bin transactions in accordance with one or more embodiments;

FIGS. 4A and 4B are illustrations of plug-in and bin properties for bin transactions in accordance with one or more embodiments;

FIG. 5 is a process flow diagram of a method for providing bin transactions in accordance with one or more embodiments;

FIG. 6 is a process flow diagram of a method for conducting bin transactions in accordance with one or more embodiments;

FIG. 7 is a schematic diagram of possible integration points for implementing bin transactions in accordance with one or more embodiments;

FIG. 8 is a scenario illustration for providing portability for bin transactions in accordance with one or more embodiments;

FIG. 9 is a scenario illustration for providing bin transactions from a shopping kiosk in accordance with one or more embodiments;

FIG. 10 is a scenario illustration for providing sharing of transaction bins for bin transactions in accordance with one or more embodiments;

FIG. 11 is a scenario illustration for providing multiple bins for social networking for bin transactions in accordance with one or more embodiments;

FIG. 12 is a scenario illustration for providing bin transactions for television shopping in accordance with one or more embodiments;

FIG. 13 is a scenario illustration for providing game console shopping and portability for bin transactions in accordance with one or more embodiments;

FIG. 14 is a scenario illustration for providing multiple bins for group shopping for bin transactions in accordance with one or more embodiments;

FIG. 15 is a scenario illustration for providing community and gift bins for bin transactions in accordance with one or more embodiments; and

FIG. 16 is a scenario illustration for providing flick transactions, such as making a payment, for bin transactions in accordance with one or more embodiments.

Embodiments of the invention and their advantages are best understood by referring to the detailed description that follows.

### DETAILED DESCRIPTION

In one embodiment, a user first accesses an online site of a seller or merchant from the user's device, which can be a PC, laptop, smart phone, tablet, or any suitable computing device. The site may include a list of different items or services, including digital goods, available for purchase. The listing may be, for example, an image, icon, or written description, including information on the item and price. The user selects the desired item in any suitable manner, such as, but not limited to, pointing and clicking, touch and hold, using a finger, or moving a mouse over. The user moves the item out of the web page, such as by dragging with the mouse, moving the mouse, or moving using a finger, for example. The item is then placed into a bin on the user device, such as by releasing a mouse or finger. The user may need to reduce the screen size of the web page if the web page fills the entire screen, so that the bin is visible, or the bin may be configured to always appear on the top of all windows. Alternatively, with a full-size screen, the bin may still be visible, such as an overlay or underlay to the screen. If the selected item requires additional information, such as a size or color, the user may be asked to enter such information at any time, such as after selection of the item or after placing the item in the bin.

The bin can reside on the user device, such as on the desktop or home screen. The bin may also be implemented on a pop-up window, such that the user can easily drag and drop an item from a merchant screen to a bin on another screen or window. It may also be an in-app program which is enabled as a popup with a press-and-hold action. The bin may be regarded as an active process and may include software for performing processes related to, for example, initiating, performing, and completing a transaction; the bin may include data objects for storing information and may have various properties associated with it, such as a unique bin identification (ID). Once the item is placed into the bin, information about the item is obtained, such as the price, the merchant or merchant ID, and shipping costs, for example. The information may be compared with the bin properties, which may include a pre-approval amount, shipping address, and user identifier, for example. If pre-approval and any other conditions are met, the payment service provider may process the transaction, such as by making the payment to the merchant, and debiting an account of the user. Factors for pre-approval may include, for example, whether the user is connected to the Internet, whether the purchase amount is within a set dollar amount, whether the merchant is an approved merchant, whether the item is an approved item, and whether the merchant ID exists in the transaction bin.

The transaction may be approved without further action by the user, or the user may be asked to confirm the transaction. After the transaction has been approved, a receipt of the transaction may be generated. The receipt can then be communicated to the user through the bin, for example, by email, or other means. Transactions through the bin may be saved and accessed later through the bin. In some embodiments, items placed in the bin may not be automatically processed and purchased. For example, the user may have the option of just holding items in the bin, without purchasing, for later payment.

Various embodiments of the transaction bin may be used to replace the well-known shopping cart at a website, which may produce a feeling in the user of actually buying the item and delivering into the user's own bin. Embodiments of the transaction bin may be expected to be very user-friendly for multi-touch devices, kiosk scenarios at the airport, portability, sharing and display of bins on social media sites, gift giving into an individual's bin as well as with community bins, and TV and game console shopping.

Various scenarios are possible with the bin. For example, the bin may be shared with others, such as through a social media site. The bin may also include visible categories into which various transactions are placed and stored. The user may have the ability to load the bin onto different devices. In such a case, the bin may be stored on a universal serial bus (USB) stick or other memory device that can be inserted into a computer. After reading the memory, the bin may appear on the device for use. The bins can be combined to form a “community” bin, and bins can be moved in and out of the community bin. Community bins allow a user to share purchases and items with others. In addition to conventional user devices for purchasing, such as PCs and smart phones, the described bin shopping may also be applied to televisions, where the user can “drag and drop” an item, program, or digital good into a bin on the television. Bins may also be used in game consoles to purchase games, upgrades, or other digital goods. For publicly available devices, multiple bins can be used so that different users can make purchases on one device by dragging and dropping items to their respective bins. A user may also drag and drop an item into another user's bin to process a purchase by the user for another. Further embodiments allow a user to “flick” items or bins between devices so that a user can make a purchase or transfer goods from one device to another using methods described in commonly-owned U.S. patent application Ser. No. 12/892,234, incorporated by reference in its entirety. Note that purchasing screens, such as an online site, can be for any seller or payee that is transacting online and making goods or services available for purchase. One example is an online marketplace, such as eBay® or Amazon®. Other examples are individual companies or retailers, such as Best Buy®, and individual sellers having an online page.

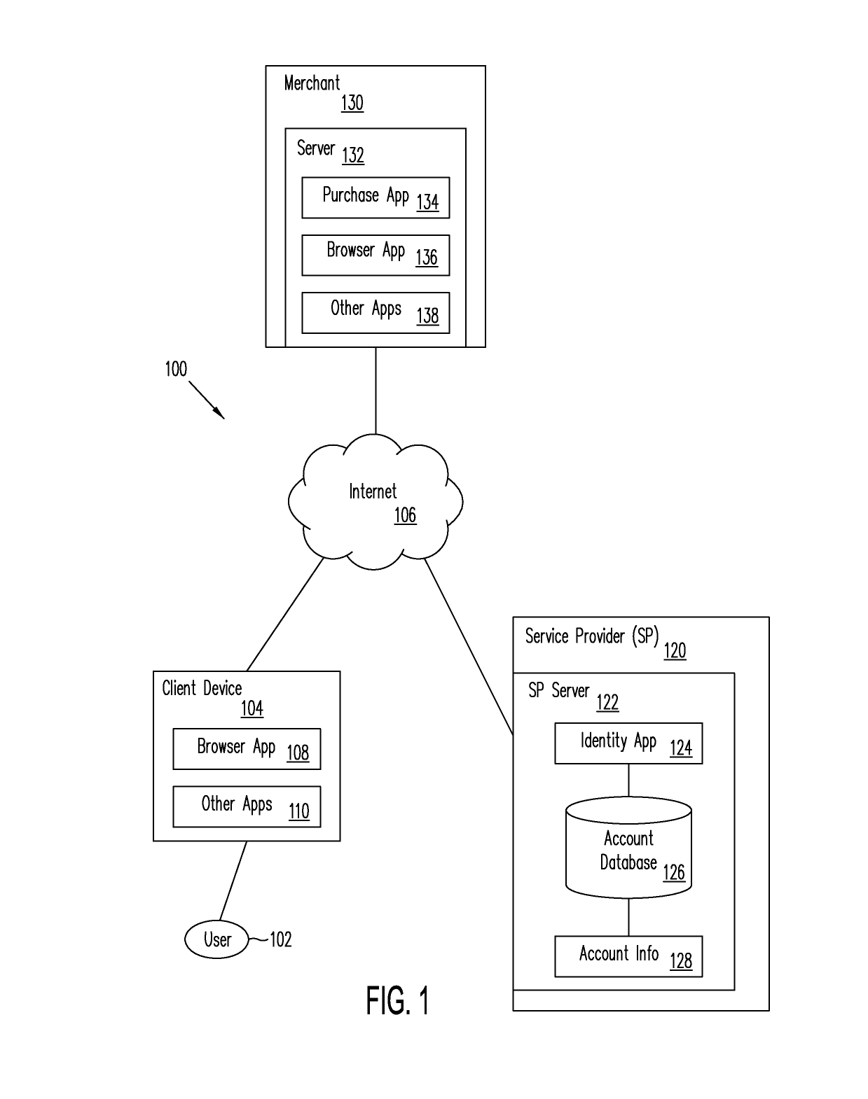

FIG. 1 illustrates a system 100, in accordance with one or more embodiments, for making a purchase (or other financial transaction) by a user 102 using a mobile device 104 (also referred to as “user device”) to communicate over a network 106 (e.g., the Internet) to a commercial entity (e.g., merchant 130) using a service provider 120. The service provider 120 may be a payment provider or other provider of financial services, such as PayPal, Inc. of San Jose, Calif. Network 106 may be implemented as a single network or a combination of multiple networks. For example, in various embodiments, network 106 may include one or more intranets, landline networks, wireless networks, or other appropriate types of communication networks including the Internet. In another example, the network may comprise a wireless telecommunications network (e.g., cellular phone network) adapted to communicate with other communication networks such as the Internet.

Mobile device 104 may be, for example, a laptop, smart phone, tablet, or other mobile computing or communication devices, televisions with Internet connection, set-top boxes or other network-connected devices. Mobile device 104, which may function as a client (and may also be referred to as “client device” or “user device” 104) may be implemented using any appropriate combination of hardware and software configured for wired or wireless communication over network 106. For example, mobile device 104 may be implemented as a personal computer of user 102 (e.g., a client or customer) in communication with network 106. Also for example, mobile device 104 may be implemented as a wireless telephone (e.g., cell phone), personal digital assistant (PDA), or notebook computer.

As seen in FIG. 1, a browser app 108 may run on mobile device 104 and may be used to provide a user interface to permit user 102 to browse information available over network 106. For example, browser app 108 may be implemented as a web browser to view information available over network 106. In one implementation, browser app 108 may comprise a software program such as a graphical user interface (GUI) executable by a processor that is configured to interface and communicate with merchant 130 and service provider 120 via network 106. For example, user 102 may access merchant websites via merchant 130 to find and purchase items. User 102, through client mobile device 104, may also communicate with service provider server 122 to create an account and make a payment to the merchant 130 via service provider 120. Mobile device 104 may include other apps 110 as may be desired to make additional features available to user 102, including making payments via service provider server 122. For example, apps 110 may include interfaces and communication protocols that allow the user 102 to receive and transmit information through online sites via network 106. Apps 110 may also include security applications for implementing client-side security features, programmatic client applications for interfacing with appropriate application programming interfaces (APIs) over network 106 and various other types of generally known programs and applications.

Merchant 130 may be a service provider (for example, a merchant site, an auction site, a marketplace, or a social networking site including P2P money transfer or any other P2P-like information transfer) offering various items such as products or services through their website. Merchant 130 (which could be any representative or employee of the merchant) may process online transactions from consumers making purchases through the merchant site from mobile devices. Merchant 130 also may operate a merchant server 132 capable of handling various on-line transactions automatically, for example, by communicating over network 106 with client mobile device 104 and service provider server 122. Merchant server 132 may run a purchase app 134 for offering products or services for purchase. Merchant server 132 may also run a browser app 136 and other applications 138. Browser app 136 and other applications 138 may enable the merchant to access a service provider 120 web site and communicate with service provider server 122; for example, to convey and receive information to allow a quick payment through the service provider 120. In accordance with one or more embodiments, consumers (e.g., user 102) may access apps for making transactions (e.g., payments) with a merchant 130 through a service provider 120) without having to log in or with the ability to input login information configured automatically in the app setup. These features may enable quicker service (e.g., completing payment processing) with service provider server 132.

Service provider 120 may be an online payments provider, for example, providing processing for online financial and information transactions with a merchant 130 on behalf of a user 102. Service provider server 122 may include one or more identity apps 124, which may be adapted to interact with the client mobile device 104 as well as merchant server 132 over network 106 to facilitate the purchase of items, products, and services by user 102. Service provider server 122 or the bin on client device 104 may be configured to maintain multiple user and merchant accounts or IDs in an account database 126; each merchant account may include or be separate from account information 128 associated with individual users, including user 102 and one or more merchants 130 (the account information can also reside on the client device as specified in the properties of the transaction bin). For example, account information 128 may include identity information of user 102 and merchants 130, such as one or more full names, business names, street addresses, email addresses and phone numbers, website addresses, or other types of financial information, which may be used to facilitate online transactions between user 102 and merchants 130. Account information 128 or identity app 124 may also include device identifiers (e.g., unique device identifier present on the device, as described above, such as IMEI number) for user devices such as mobile device 104. Thus, identity app 124 may be configured to interact with a merchant server 132, a user 102, mobile device 104, or other payee to process, obtain, and store information for allowing payments via service provider 120.

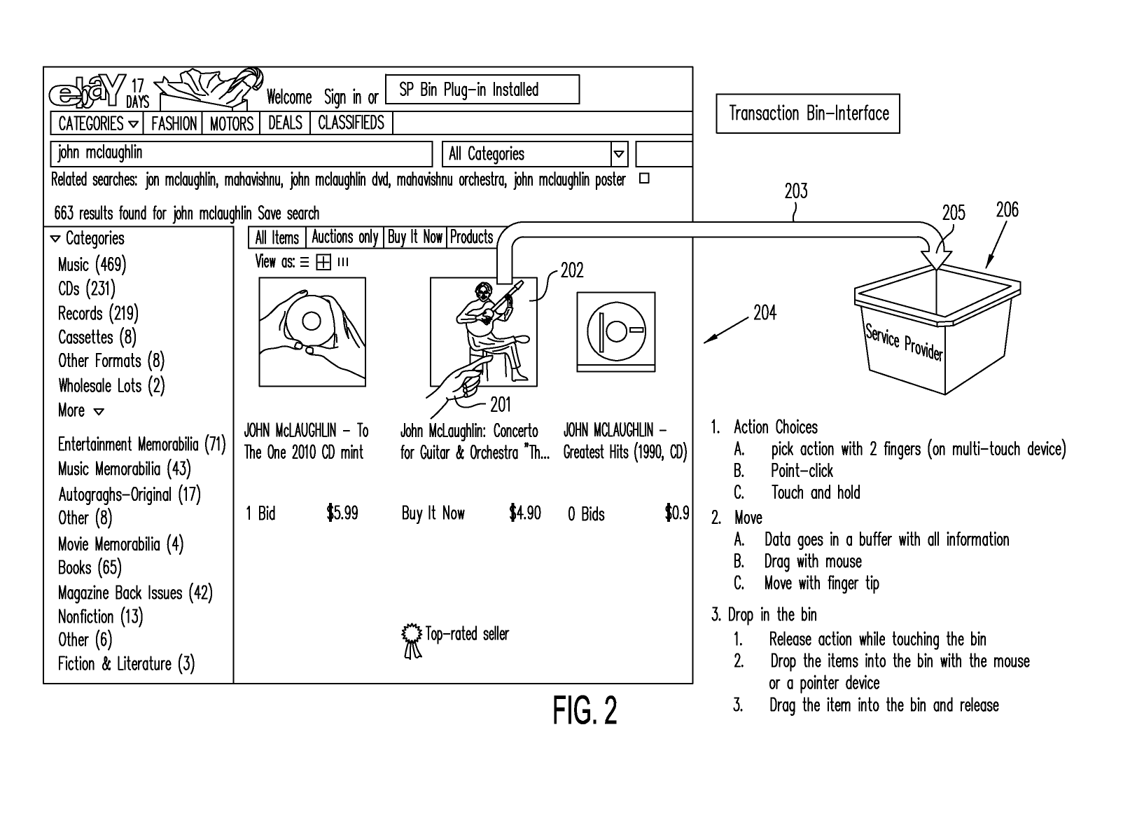

FIG. 2 illustrates a user interface for electronic transactions using a bin (bin transactions) in accordance with one or more embodiments. FIG. 2 illustrates an action of selecting 201 an item 202 from a web site 204, moving 203 the item, and placing 205 the item into a transaction bin 206, which may, for example, be stored as a data object on a user device. Web site 204 may be, for example, a marketplace website such as eBay®, a merchant that accepts payment via a service provider, or a site that only accepts direct payments. The web site 204 may or may not have its own shopping cart. As shown in FIG. 2, the selecting action 201 may comprise, for example, a pick action with two fingers (on a multi-touch device), a point-and-click with a mouse, or touch-and-hold. The moving action 203 may comprise, for example, dragging the selected item with a mouse or moving the selected item with a finger tip so that transaction data goes into a buffer with all information needed about the merchant and the user, for example. The placing action 205, or dropping the item in bin 206, may comprise, for example, a release action while touching the bin, dropping the item into the bin with the mouse or a pointer device, or dragging the item into the bin and releasing.

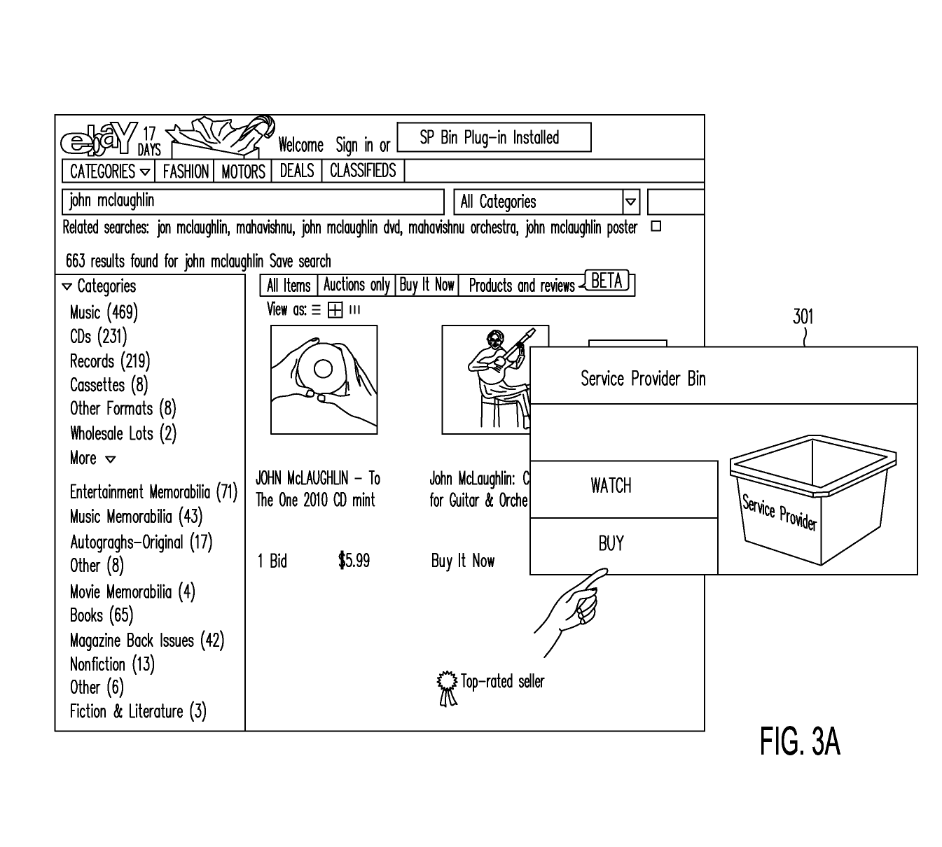

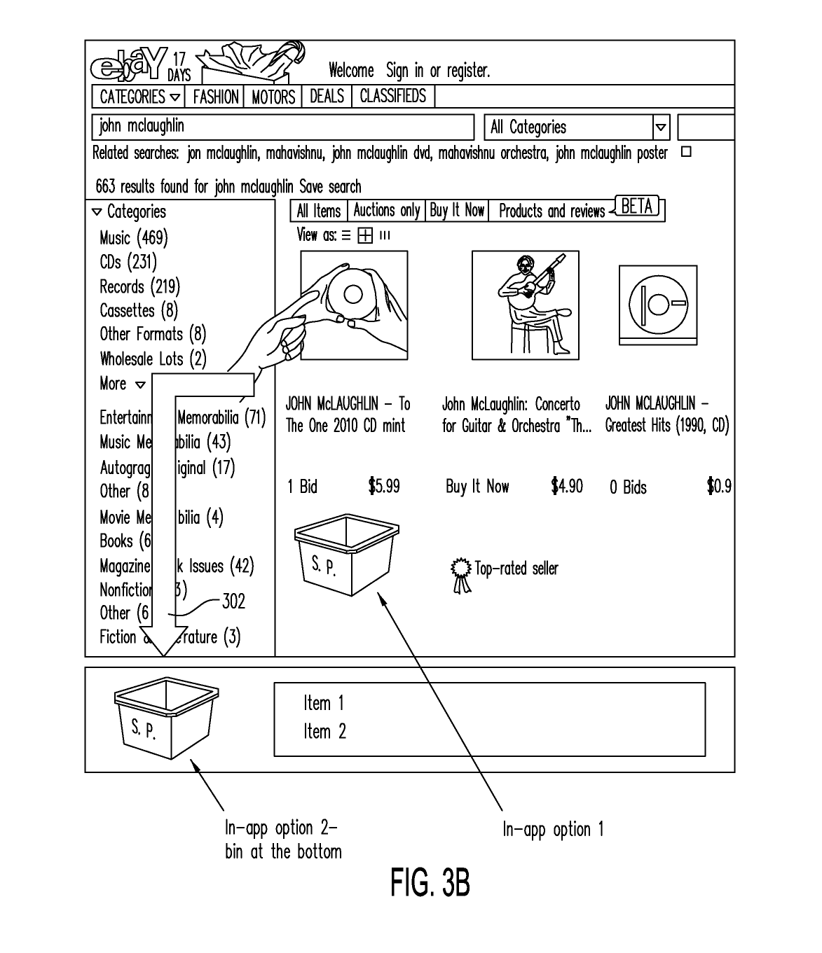

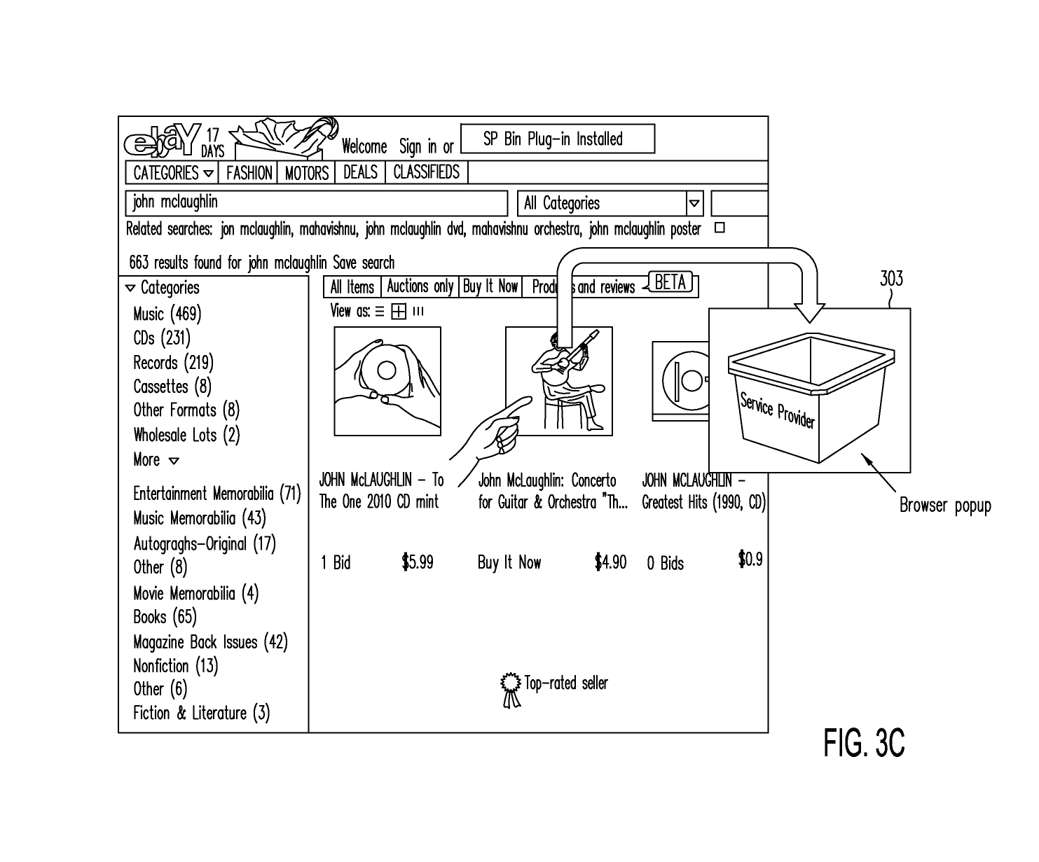

FIGS. 3A, 3B, and 3C illustrate alternative user interfaces for bin transactions in accordance with one or more embodiments. FIG. 3A, for example, shows an implementation using an in-app contextual menu 301 that may appear when the user touches the screen or moves a mouse over the item. FIG. 3B illustrates an example of two options. In one option the bin (e.g. bin 206 of FIG. 2) may displayed on the browser page as shown in FIG. 3B. In another option, the bin may displayed off the browser page as shown in FIG. 3B. In either option, an item may be selected, moved, and placed in the bin as indicated by arrow 302. For some types of devices, the options may be implemented for in-app browsers, while for other types of devices, where the environment is open, the options may be implemented as a plug-in or an extension with the application itself. FIG. 3C illustrates an implementation using a browser popup 303. For browser implementation, the transaction bin may be implemented using a platform such as ActiveX®, Java®, or Flash®; browser plug-in, browser extension, operating system (OS) extension, or software on the desktop. For any of these implementations, it may be easier to implement the bin as a pop-up browser window in which the user can select an item from one window and move it to the popup browser window which may look like a bin. The bin may be integrated with web services by use of an API. For example, a service provider or merchant may have a published API, such as Google® maps or Amazon® APIs. When an API is not available, web scraping (e.g., a computer software technique of extracting information from websites) may be used. Other techniques for gathering information (e.g., transaction information, item information, merchant ID) may include use of the website's uniform resource locater (URL).

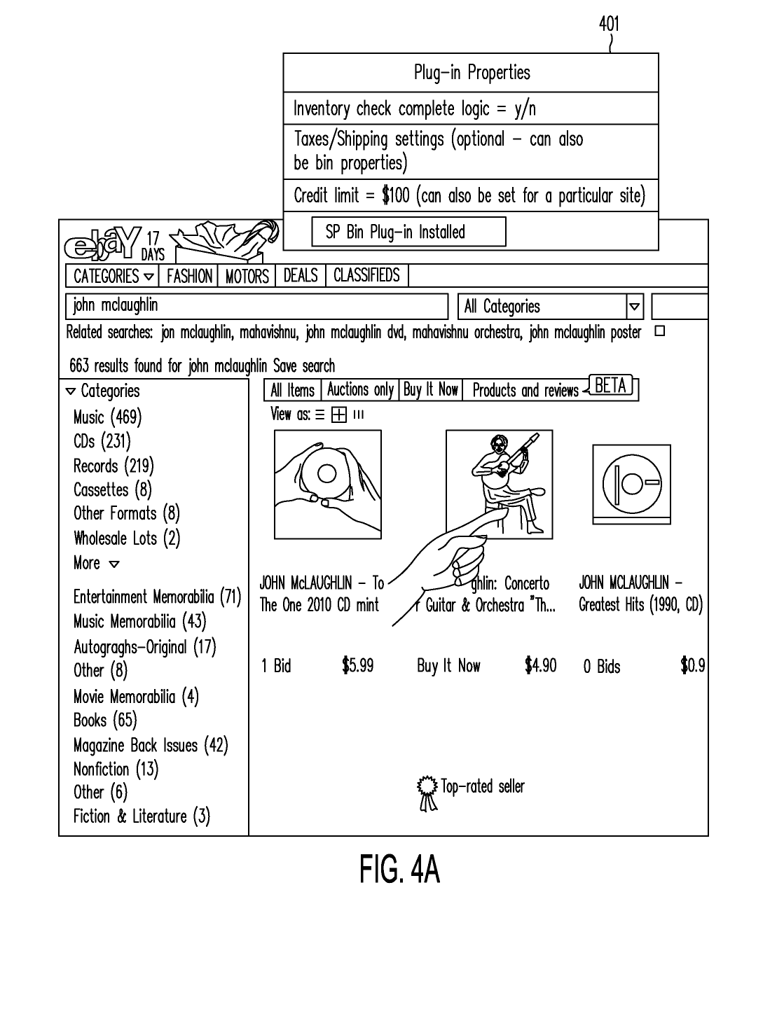

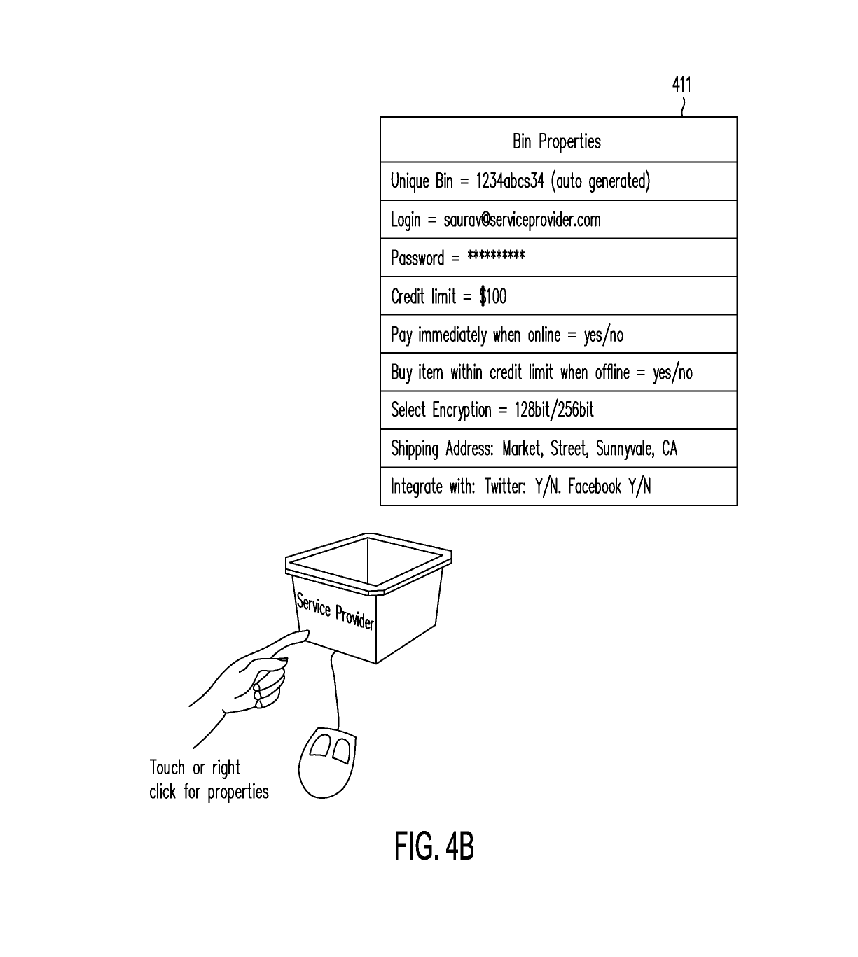

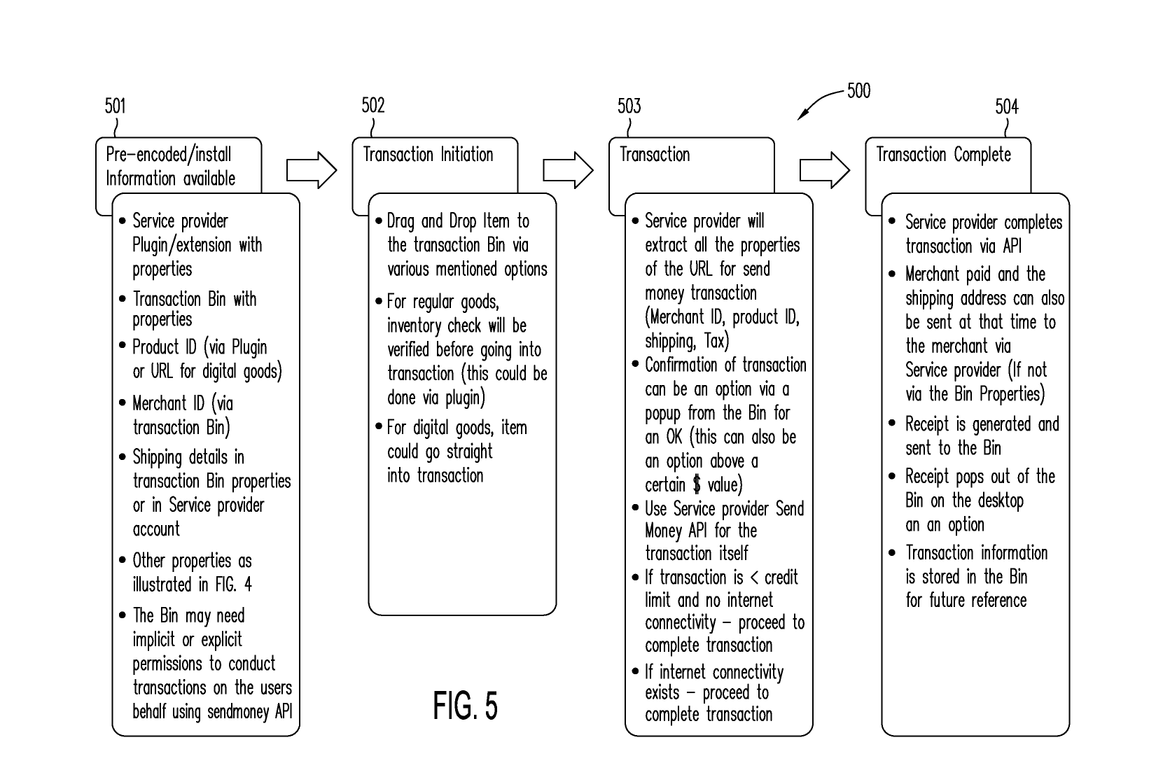

FIGS. 4A and 4B are illustrations of plug-in and bin properties for bin transactions in accordance with one or more embodiments. FIG. 4A shows an example of bin properties for a plug-in or a desktop application implementation of a bin, displayed as a table 401. As shown in table 401, properties included in the bin may comprise various information associated with the bin such as credit limit of the user, tax and shipping options of the user, and inventory checks for the merchant. For example, a custom plug-in or extension may be required for a particular website for inventory check, e.g., if the item has different sizes and color selection. FIG. 4B shows an example of bin properties for another implementation of a bin, displayed as table 411. As indicated in FIG. 4B, table 411 may be displayed for the user by, for example, touching the screen or right clicking the mouse. Various bin properties in table 411 may be set by the user, e.g., password, and other properties may be set only by the service provider, e.g., credit limit. A merchant ID may be pre-encoded in the bin or can be entered manually or gradually programmatically as more and more merchants adopt the drag and drop shopping feature (e.g., the shopping bin). Server side bin properties can be updated (e.g., new merchant IDs added) online by auto-update. Product ID can also be included or can be imported via a plug-in or extension on the website. The bin can have a unique ID (e.g., auto generated unique bin ID as shown in table 411) to help with other features.

FIG. 5 illustrates a method 500 for providing bin transactions in accordance with one or more embodiments. A process 501 of making pre-encoded and install information available may include, as shown in FIG. 5, providing (e.g., from a service provider) a plug-in or extension with bin properties (for example, as illustrated in FIGS. 4A and 4B); a transaction bin with properties (e.g., as shown in FIGS. 4A and 4B); a product ID (via plug-in or URL for digital goods); a merchant ID (via the transaction bin); shipping details (via the transaction bin properties or via the user's account, e.g., from account information 128 shown in FIG. 1); and other properties (e.g., as exemplified in FIGS. 4A and 4B). The transaction bin may need implicit or explicit permissions to conduct transactions on the user's behalf using, for example, an API for sending and receiving money.

A process 502 of transaction initiation may include dragging and dropping an item to the transaction bin via various options a previously described, for example, with reference to FIGS. 2, 3A, 3B, and 3C. For ordinary (e.g., non-digital) goods, an inventory check may be verified before going into the transaction bin (a plug-in, for example, may be used to implement this). For digital goods (e.g., music and video downloads), the item may go directly into the transaction bin.

A process 503 of performing the transaction may include the bin (regarded as an active process) extracting properties of the URL (e.g., the merchant's website) for a send money transaction; the properties may include, for example, merchant ID, product ID, shipping information, and tax information. Process 503 may include an option of confirmation of the transaction via a popup from the bin for an OK from the user; such confirmation could also be automatically triggered by transaction amounts exceeding a certain threshold, which could be user-defined or service provider-defined. Process 503 may include using an API defined by the service provider for various methods of payment and may include various tests and checks for proceeding to complete the transaction, for example, involving combinations of factors such as internet connectivity and credit limit as shown in the example illustrated in FIG. 5.

A process 504 of completing the transaction may include the service provider (e.g., service provider 120, shown in FIG. 1) completing the transaction via a service provider API. The merchant may be paid via the service provider, and the service provider may at that time send the shipping address to the merchant or the shipping address may be provided to the merchant via the bin properties. A receipt may be generated and sent to the bin. The receipt may pop out of the bin (e.g., on the desktop, user device display, or wherever the bin is being displayed to the user). The transaction information may be stored in the bin for future reference.

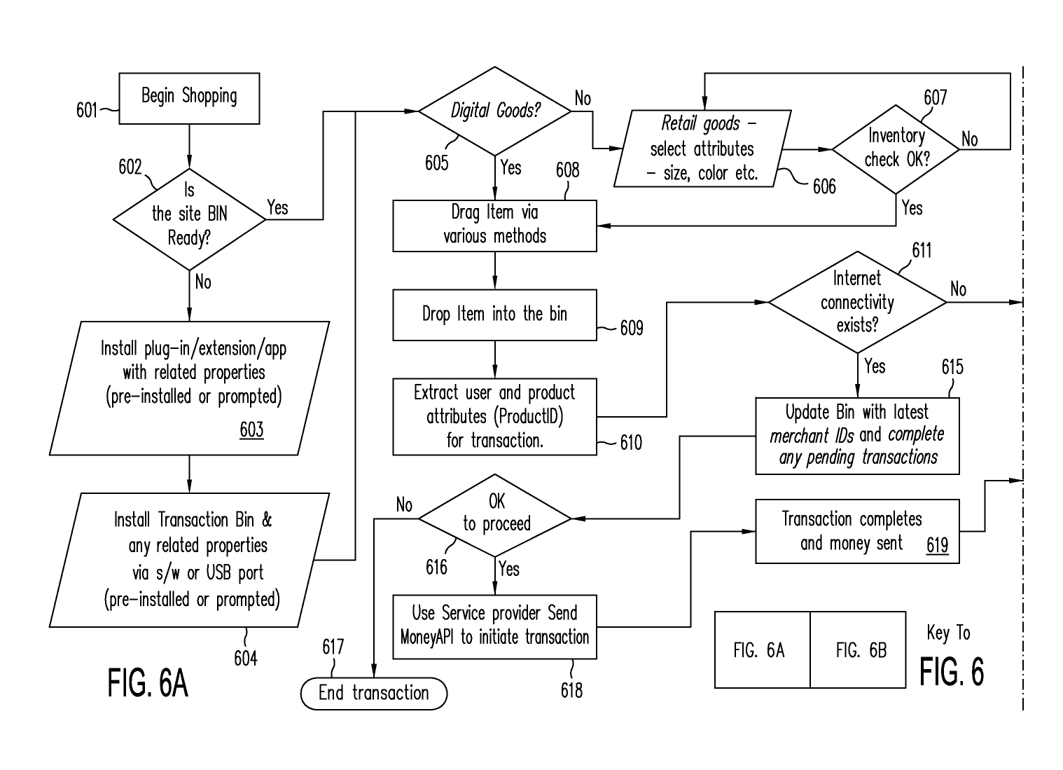

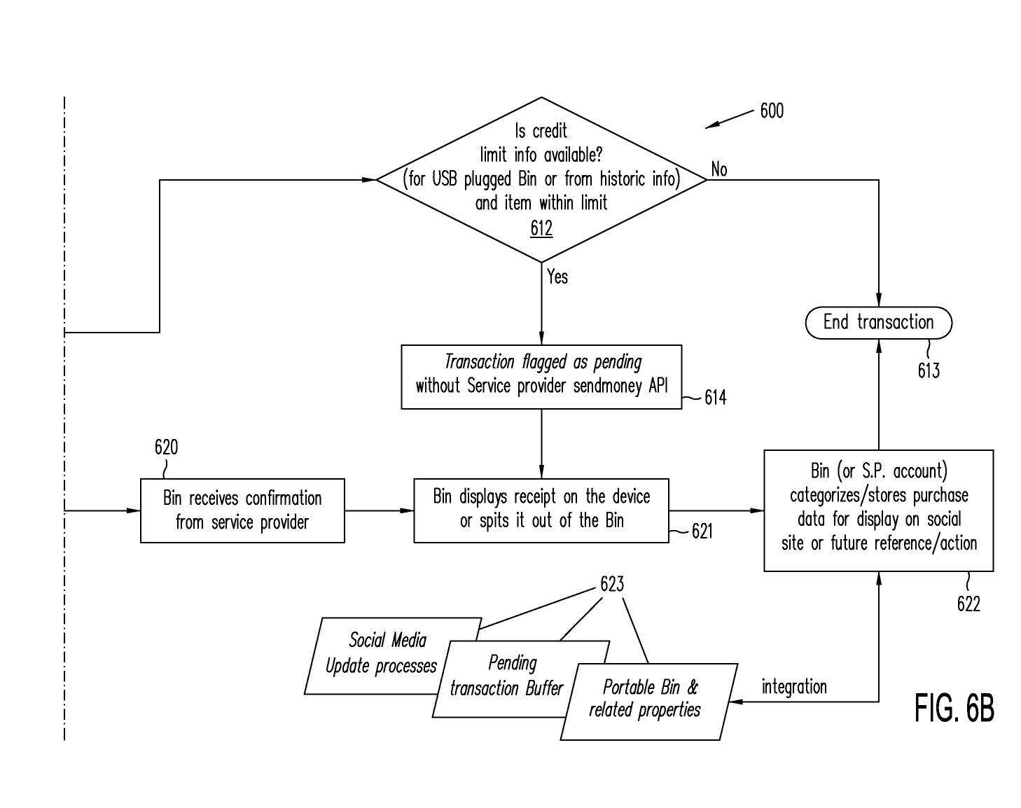

FIG. 6 illustrates a method 600 for conducting bin transactions, in accordance with one or more embodiments, which may be regarded as being from the user's point of view. At step 601, the user may begin shopping, e.g., by visiting a merchant website. At step 602, it may be determined whether or not the user has a bin available. If not, at step 603, the bin may be installed according to its implementation and along with its properties, or activated if pre-installed, e.g., by responding to a prompt. At step 604, in the case, for example, of a portable bin, e.g., one carried on a USB flash drive, the bin may be installed or imported from the flash drive. Method 600 may continue, either from step 603, step 604, or, if determined at step 602 that the bin was ready, from step 602, in any case at step 605. At step 605, it may be determined whether the item for purchase involves digital goods. If not, at step 606, for ordinary or regular goods, which may involve options such as color or size selection, options may be chosen and continue at step 607 with an inventory check at the merchant's site. As indicated by the process flow illustrated in FIG. 6, once all options are chosen and inventory checks are OK, or if the transaction involved only digital goods, method 600 may continue at step 608 and step 609 where the item may be moved and placed in the bin, for example, as described above with reference to FIGS. 2 and 3. At step 610, the bin (regarded as an active process) may extract user and product attributes for the transaction. At step 611, the bin may determine whether internet connectivity exists and, if not, method 600 may continue at step 612 with credit limit and price checks to determine whether to end the transaction (step 613) or flag the transaction as pending (step 614) and continue at step 621, further described below. If internet connectivity exists at step 611, method 600 may continue at step 615 to update the bin with the latest merchant IDs and complete any pending transactions. At step 616, the bin may check, based on step 615, whether it is OK to proceed with the transaction and, if not, may end the transaction (step 617). If it is OK to proceed with the transaction, the bin may use a service provider API to initiate the transaction, e.g., by sending payment to the merchant website. At step 619, the bin may complete the transaction, e.g., money has been sent via the service provider to the merchant. At step 620, the bin may receive confirmation of transaction completion from the service provider. At step 621, the bin may display a receipt on the device on which the bin is displayed, e.g., “spits” the receipt out of the bin for further use or storing by the user. At step 622, the bin (or the service provider account) may categorize and store purchase data for use at various integration points 623, (e.g., display on social networking site, pending transaction buffer, and portable bin with related bin properties) for future reference and action.

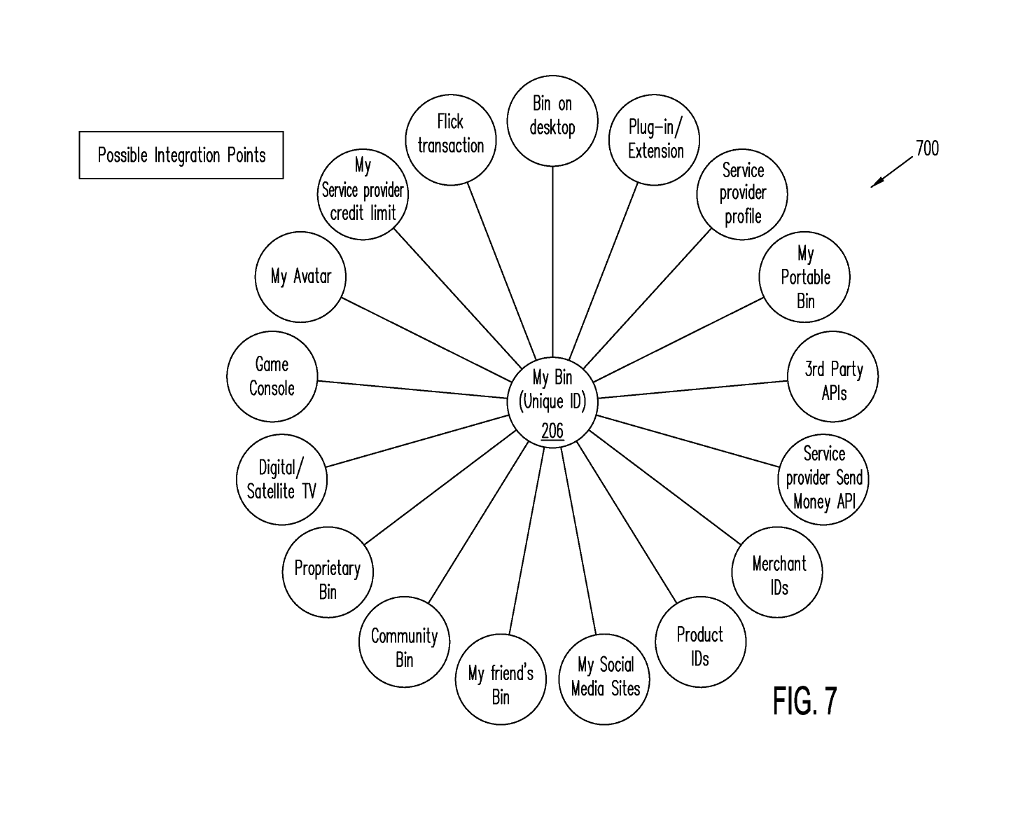

FIG. 7 shows a number of possible integration points to which the bin and methods using the bin may interrelate and function with. Such integration points 700 for the bin 206 with its unique bin ID may include, as shown, a desktop, plug-in or extension to a browser or other app, service provider profile, a portable bin (e.g., stored on USB flash drive), third party APIs, service provider send-money APIs, merchant IDs, product IDs, social media or networking websites, a friend's bin (see various scenarios described below), a community bin, a proprietary bin, digital or satellite television (TV), game consoles, avatars, service provider credit limits, and flick transactions (as described in the Ser. No. 12/892,234 patent application referenced above).

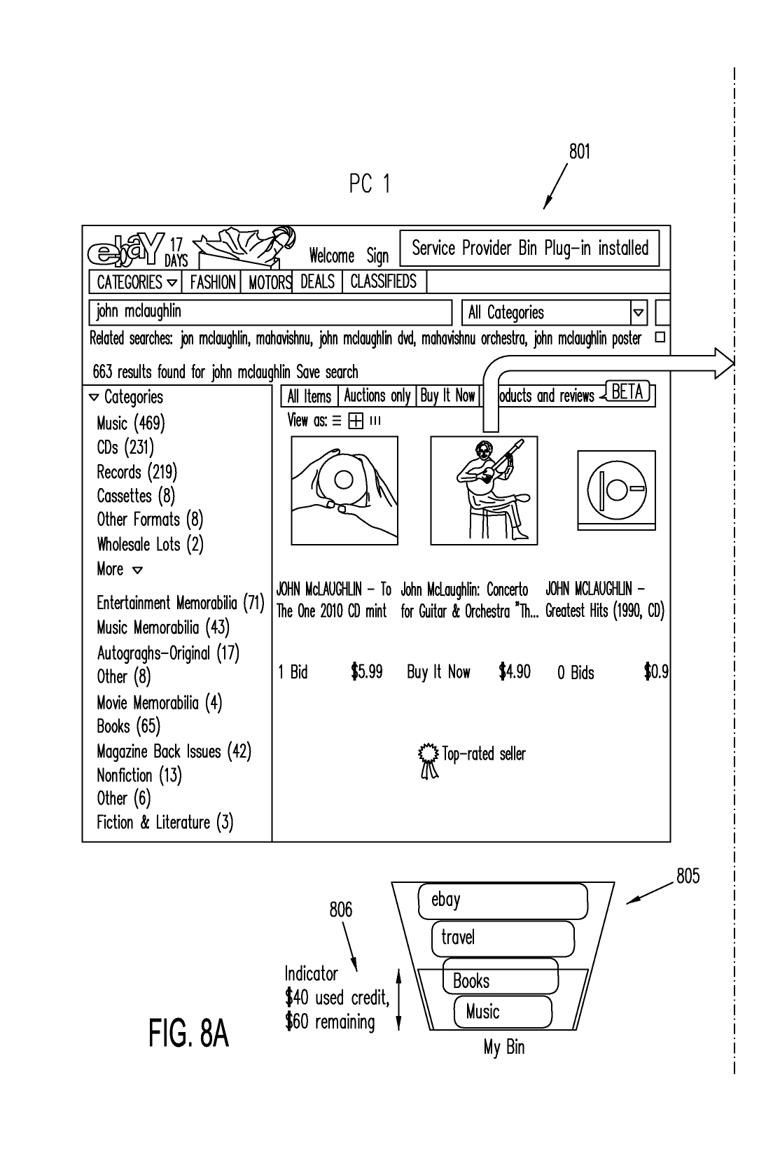

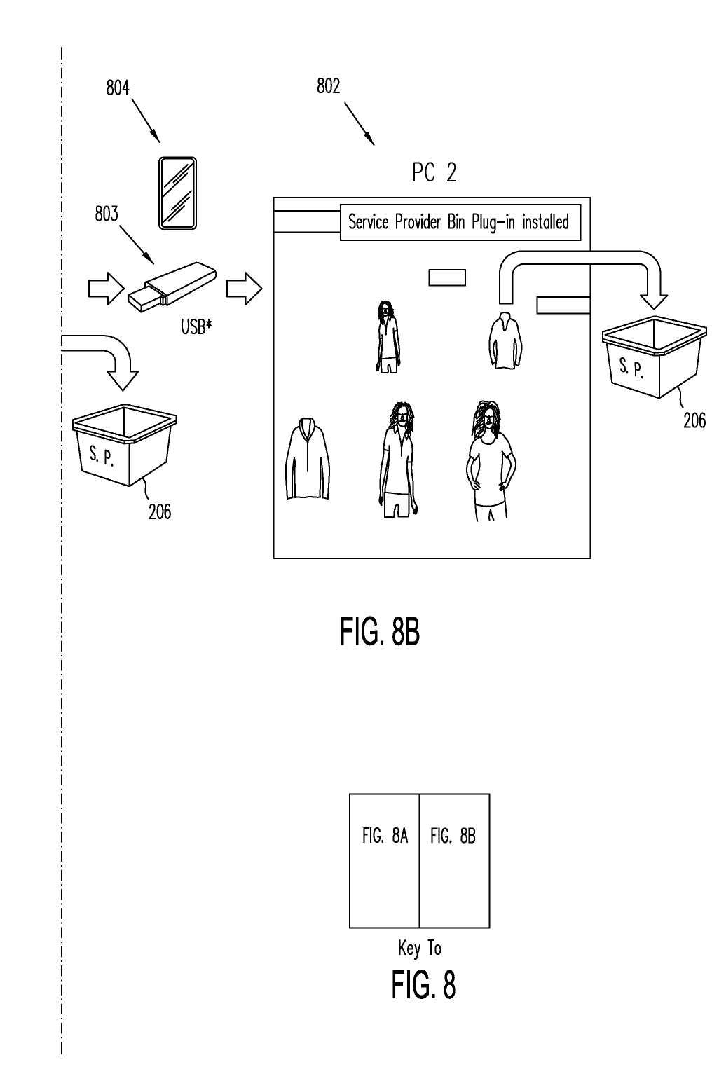

FIG. 8 shows a scenario for providing portability for bin transactions. As shown in FIG. 8, bin 206 may be operational on a first PC 801. The bin 206 may transferred to a USB drive 803, for example, or a user mobile device 804, and then transferred to a second PC 802, where the bin 206 may again become operational. It may enhance such a portable bin 206 to have a bin display 805, which may be displayed on any of the devices. Bin display 805 may have categories for purchases (e.g., categories for music, books, travel, and auction purchases are shown) and an indicator 806 for credit used and available remaining credit of the user's credit limit. Similarly a watermark or shading of the bin can indicate used credit limit for off-line pending transactions.

The “MyBin” display 805 may have a unique public name or an avatar name. The bin may be implemented as an application for desktop operating systems. The bin may appear as soon as the user plugs in the USB drive 803 into a computer, e.g., PC 802. The bin can have a credit value for ensuring transaction value offline with a limit. The bin may sync with a payment service provider to complete transactions whenever there is connectivity, e.g., Internet connectivity. The “MyBin” display 805 may be personalized or shared on social media sites. USB is just one example of a type of transfer medium that can be used; other examples include: MP3, digital media player, and smart media. The interface can also be wireless such as by using near field communication (NFC) or Bluetooth®, for example.

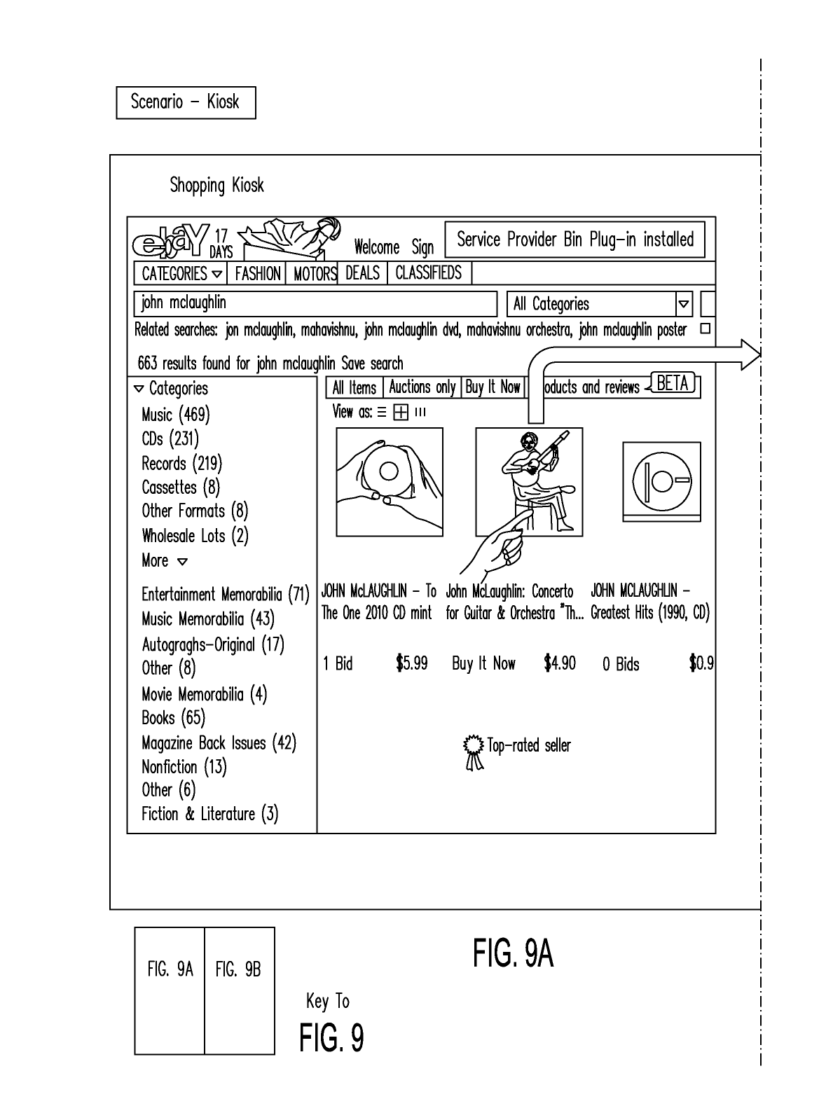

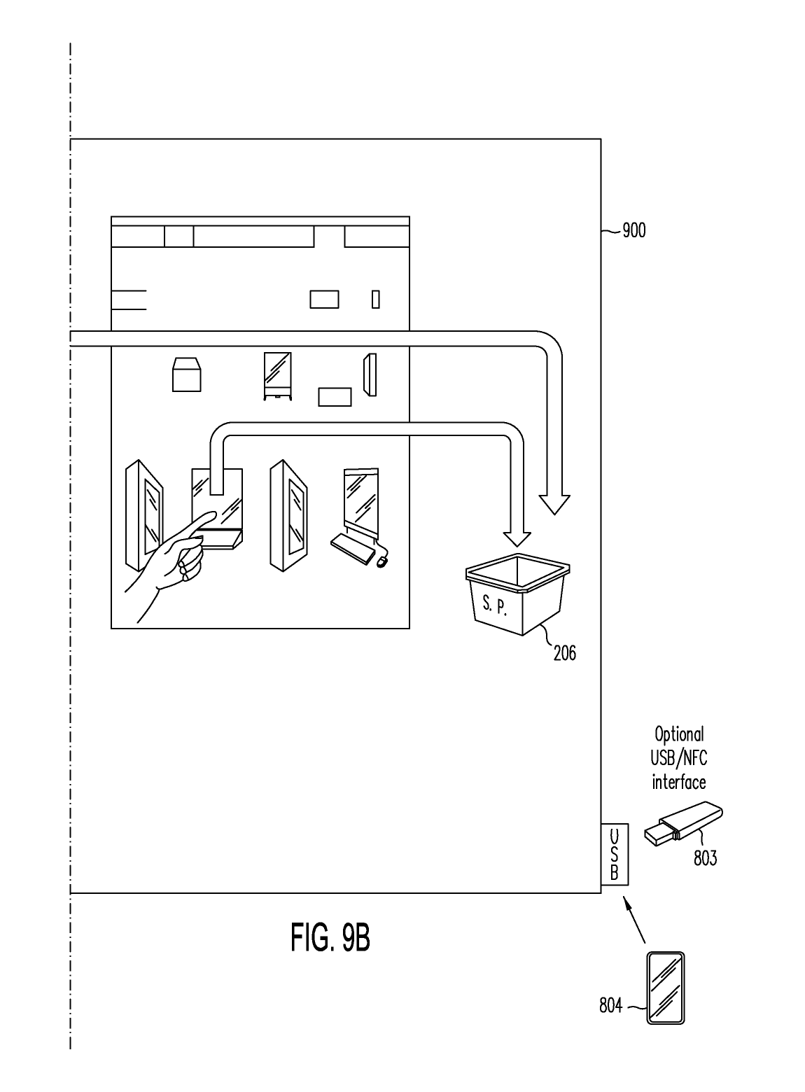

FIG. 9 shows a scenario for providing bin transactions from a shopping kiosk. A portable bin 206 may become operational at shopping kiosk 900, for example, by plugging in a USB drive 803, or communicating with a user mobile device 804, e.g., using near field communication (NFC) or wireless such as Bluetooth®. Optional USB stick 803 may be used with an application in absence of a service provider app. The app may auto-start when the USB stick 803 is inserted to the kiosk 900, and a bin 206 may appear on the screen. An optional USB or NFC interface may be used if the bin 206 is not pre-encoded. For digital goods, e.g., music and video downloads, any MP3 or video player may be plugged in to get the transaction bin 206. The transaction bin 206 may reside on the device. Whenever the user is online, the bin may sync up with the service provider profile to get attributes related to transaction.

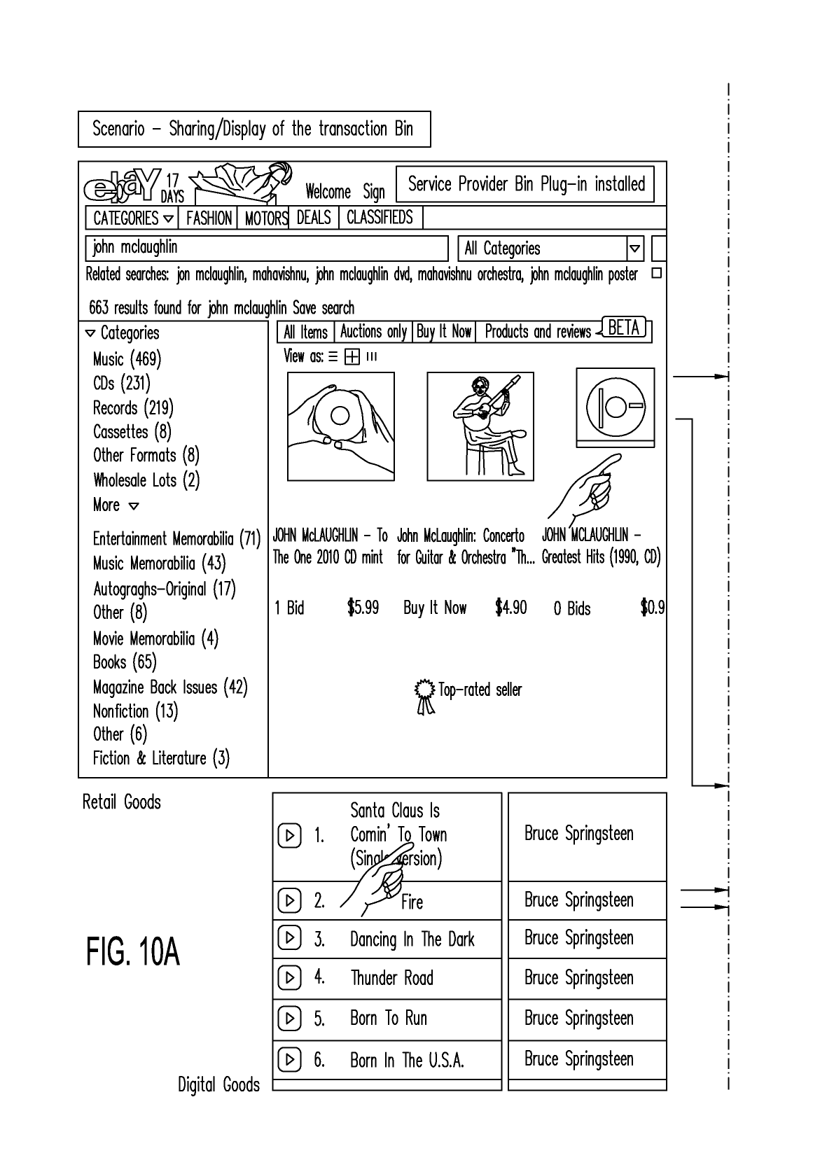

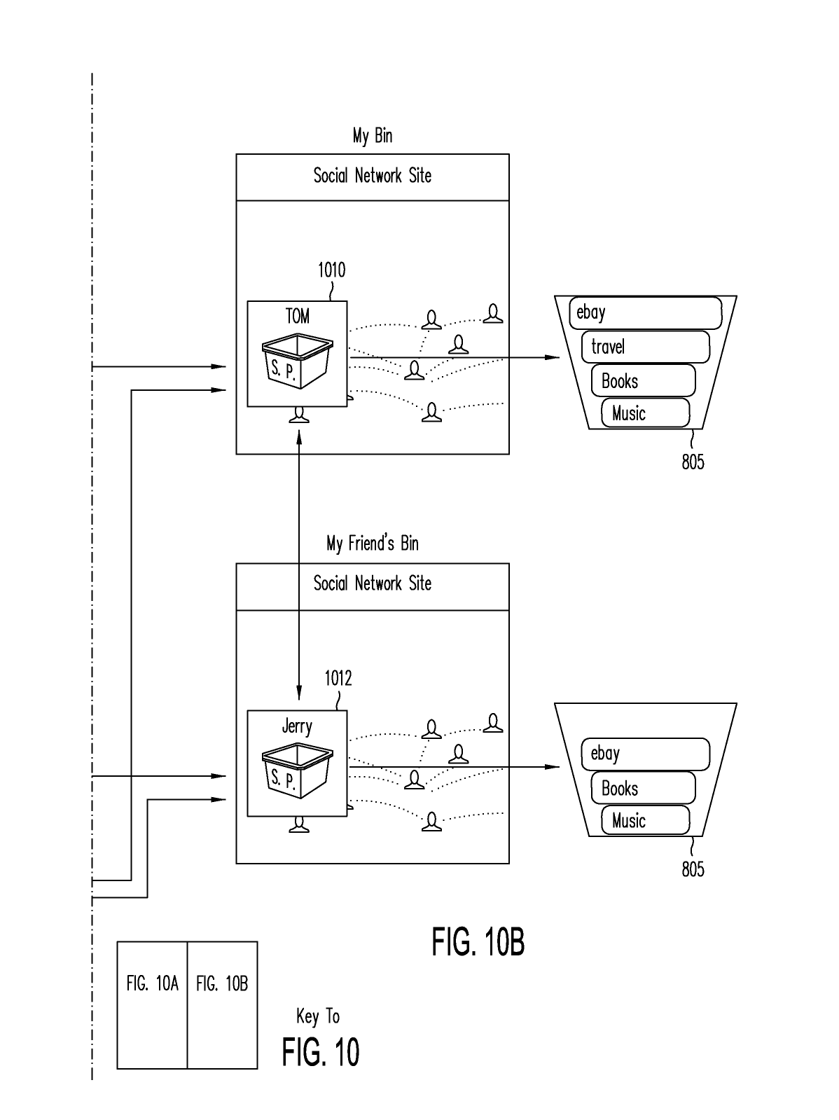

FIG. 10 shows a scenario for providing sharing of transaction bins. For example, by allowing simultaneous display of two bins on the same display, e.g., the shopping kiosk 900 of FIG. 9, and providing permissions for either or both users to access the other's bin, a user may be able to make purchases that are provided to the other user. For example, a first user may drag and drop a purchase into the friend's bin as well as the user's own bin or drag and drop a purchase from one bin to the other, as indicated by the arrows in FIG. 10. Also, as shown in FIG. 10, each bin may have a display 805 as described above with reference to FIG. 8. In one scenario, a unique bin ID for my bin 1010 can be used to make a purchase and the item can be moved to my friends bin 1012. Each bin can be displayed, as previously described, to categorize different items to showcase each user's particular interests.

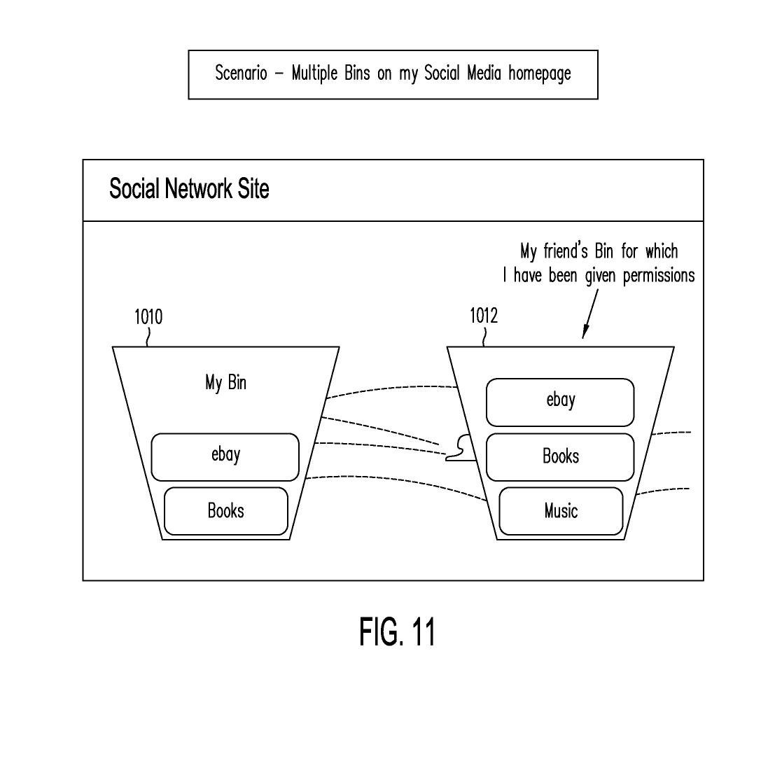

FIG. 11 shows a scenario for providing multiple bins for social networking. In a scenario similar to that for sharing bins, as described in FIG. 10, bins may also be shared via a social networking website as illustrated in FIG. 11. Multiple bins may be visible on the user's social media homepage based on permissions given by others to their bins. Additional bin permissions can, for example: allow others to see “my bin” and its categories; allow “my bin” to be displayed on my friend's social media page; and allow “my bin” to receive items purchased by others with their unique bin ID for their bin.

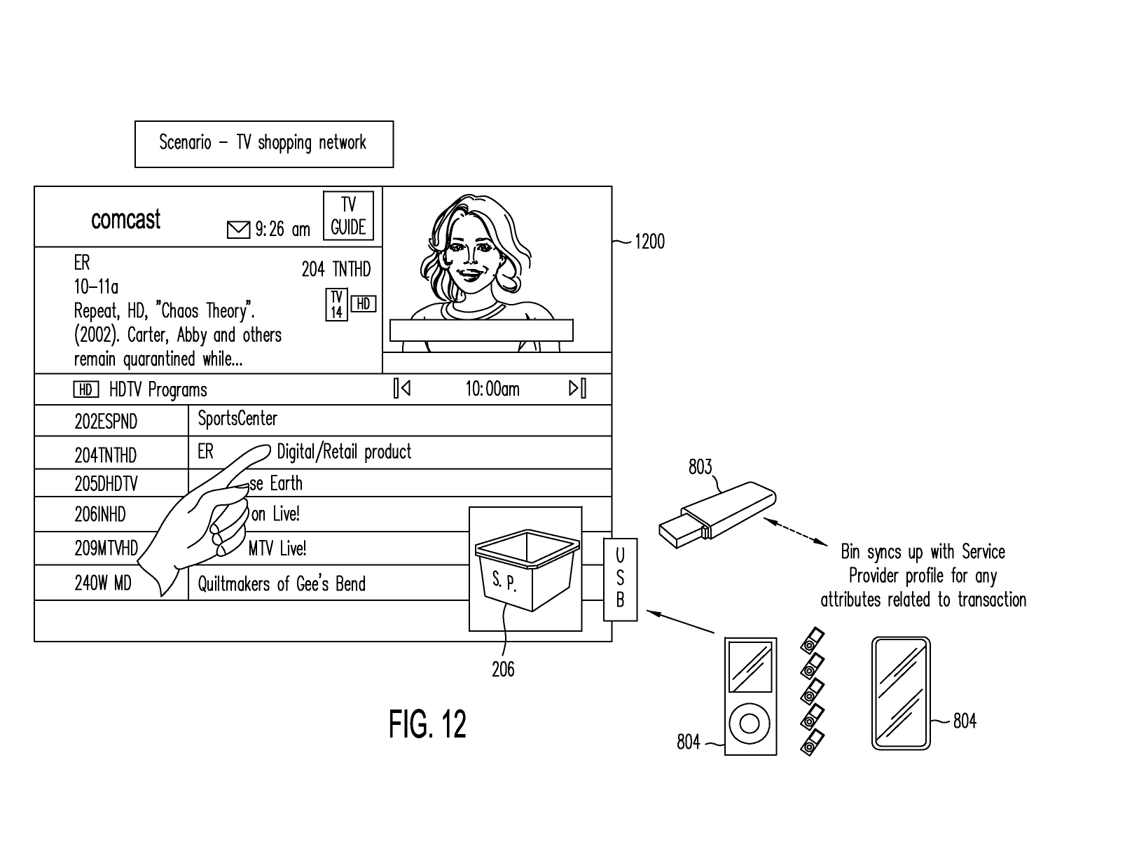

FIG. 12 shows a scenario for providing bin transactions for television shopping. Similar to the shopping kiosk scenario described above with reference to FIG. 9, a portable bin 206 may interface to a television 1200 with digital capabilities. For example, a cable, satellite, or digital TV signal may have payment attributes pre-encoded or may be provided as part of a set top box or TV firmware. Buying a product (which may include digital goods or retail goods) from a TV broadcast shopping network may be accomplished using bin 206 as long as product ID, merchant ID, API, unique bin ID and related bin properties can be transmitted to the TV 120 (e.g., via a set-top box) and interaction with a payment service provider or a payment system is enabled. As shown in FIG. 12, a portable bin 206 can be interfaced with TV 1200 via a USB drive 803 or user device 804, as described similarly above with the portability scenario (FIG. 8) and shopping kiosk scenario (FIG. 9). An item can be dragged and dropped into the bin, for example, from the television information bar at the bottom of the screen (which can highlight the product) into the bin using a point and click remote—or a touch and hold and drag-drop into the transaction bin 206. The bin 206 can be portable, as shown, or pre-encoded with the TV/cable programming. As shown in FIG. 12, the bin 206 may sync up with a service provider profile for attributes related to the transaction.

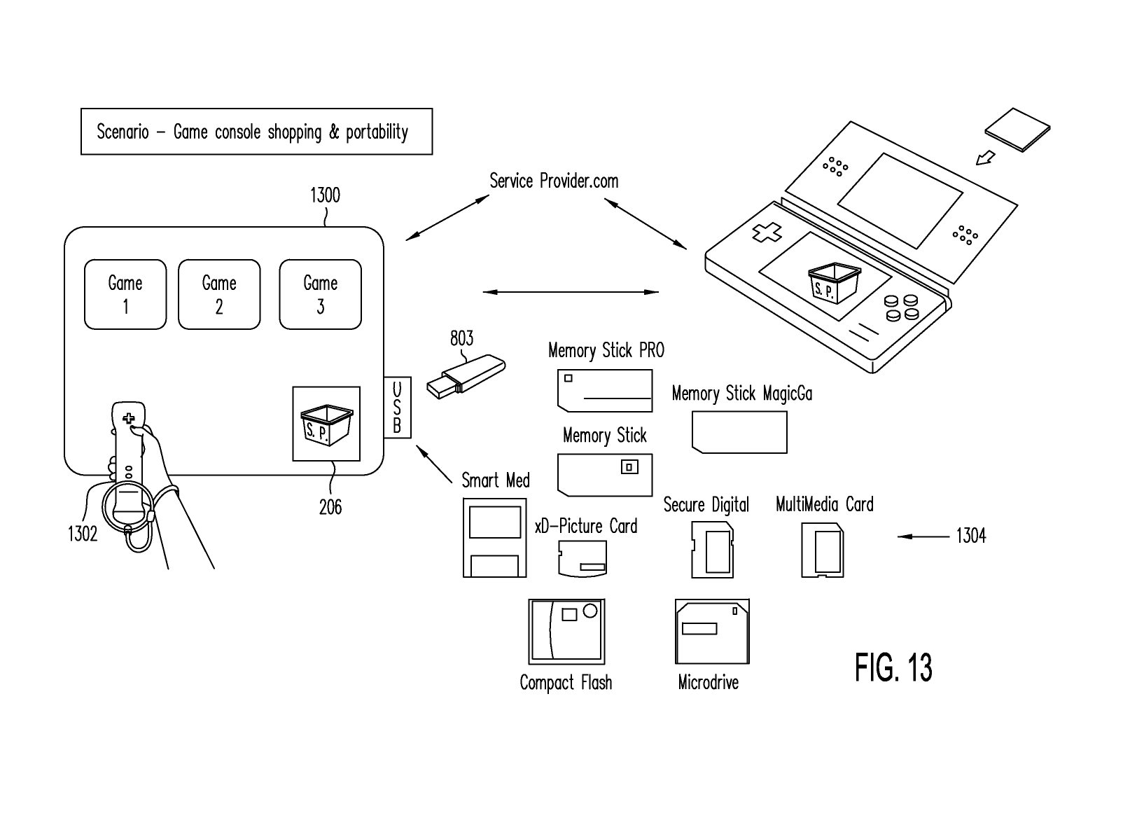

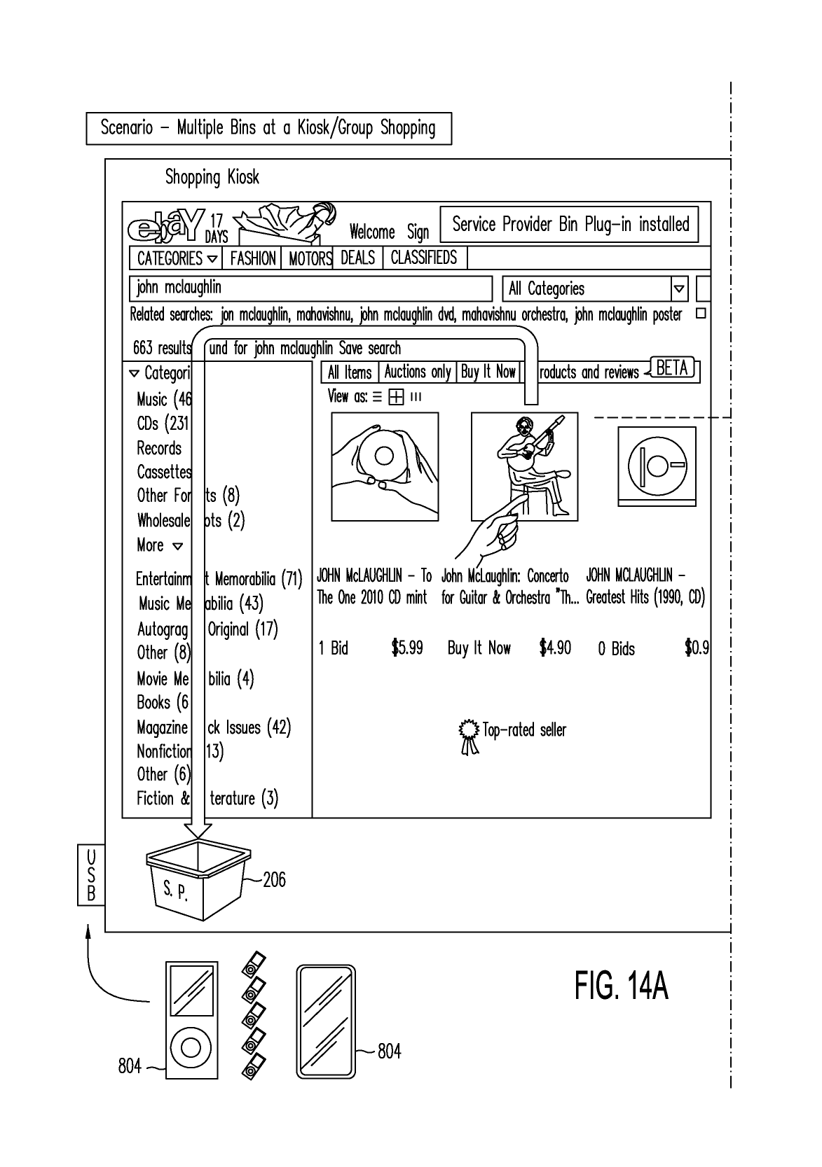

FIG. 13 shows a scenario for providing game shopping and portability for a game console 1300. The transaction bin 206 can be implemented on a game console 1300 so that the required (or desired) game can be moved into the bin 206 for purchase via a stylus or a game controller 1302 or a touch screen input if present. The bin 206 can then also illustrate the titles of the games the user has purchased and that, for example, can be shared in the user's social media environment. The bin 206 can also be made portable by various USB or supported smart media, e.g., USB drive 803 or various forms of media 1304.

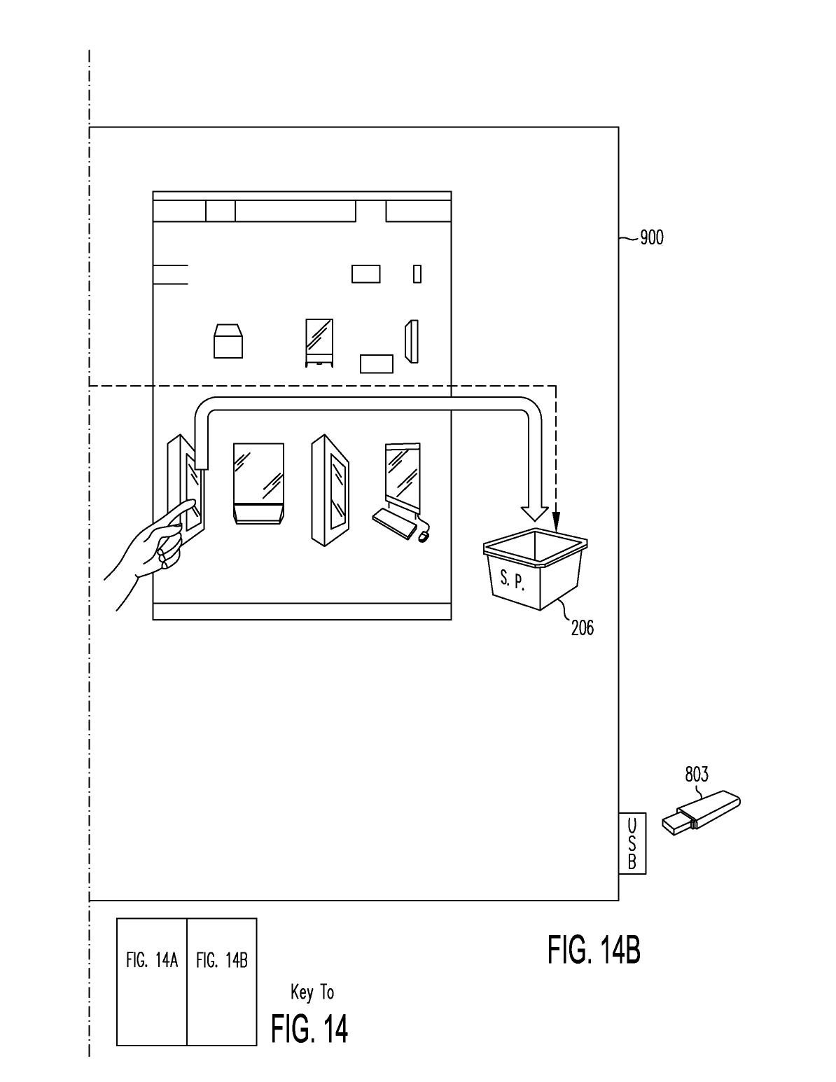

FIG. 14 shows a scenario for providing multiple bins for group shopping using bin transactions. Similar to the scenarios shown in FIG. 10 and FIG. 11, multiple bins 206 can be introduced—each with its own unique bin ID—for a shared shopping experience on the same console (e.g., game console 1300), kiosk (e.g., shopping kiosk 900), television (e.g., TV 1200) or computer (e.g., PC 801, 802). Each user can purchase with each user's own unique bin ID and, for example, can also drop into another user's bin.

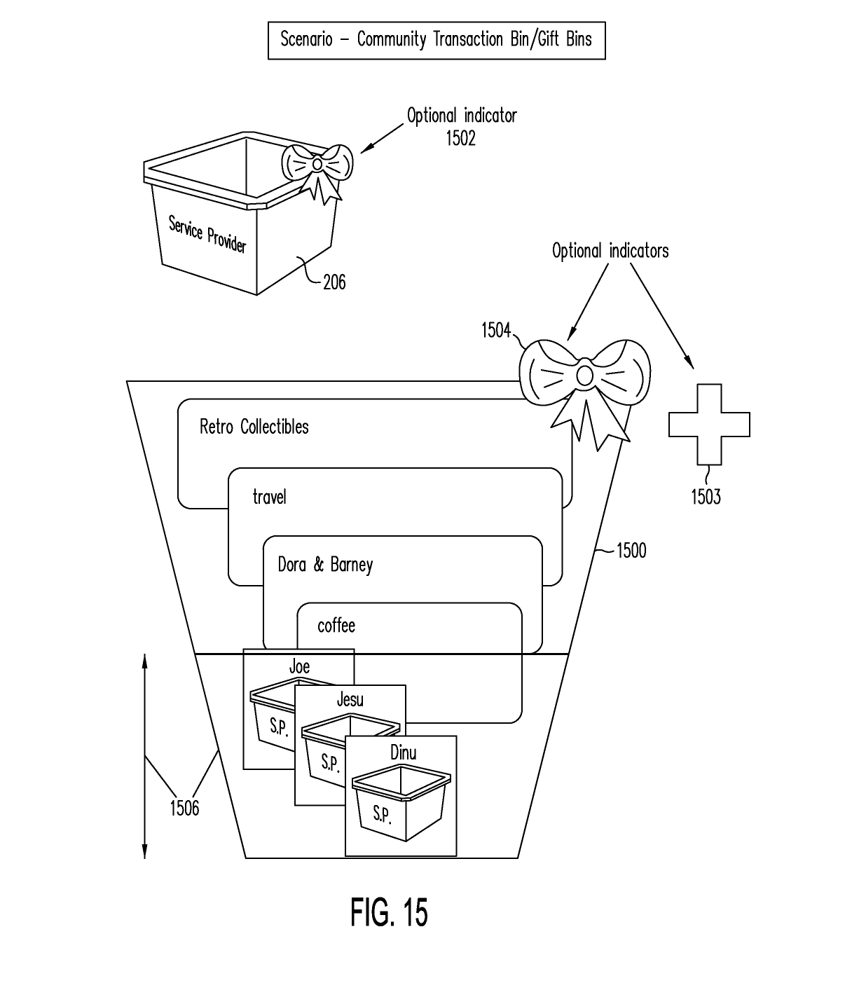

FIG. 15 shows a scenario for providing community and gift bins for bin transactions. In one example, an optional indicator 1502 (shown as a ribbon bow in FIG. 15) may be used with an individual transaction bin 206 to mark it as a gift bin. The gift bin 206 can be used, for example, as a gift basket employing a link sent via email for notification to a recipient. Optional indicators, such as indicator 1504, may be used to mark a gift community bin 1500 or a bin for a particular cause (e.g., cross indicator 1503) or the bin can also be color coded as another way of implementing an indicator like indicators 1503, 1504. An indicator 1506, such as an arrow or watermark shading of the bin 206, may be used to indicate available credit, similar to indicator 806 described above.

For social media sites, a group of bins may be combined to display a community bin 1500 to be used, for example, by a group of people who are purchasing similar categories of item. Also for example, a community bin 1500 could be used for the following: building the community itself; showcasing the group pride; and group purchases using the community bin.

A community bin 1500 may have distinct pe missions for other community bins as to whether they are able to display the community bin 1500 on their social media site or sites. Individual sites may have proprietary community bins 1500 with limited access to only certain other bins.

Other possibilities are gifts and donations of bins to individuals or community bins; gift registry; community and gift bins that may receive gifts and coupons from individuals or merchants; and a capability to auction off an individual bin or community bin on marketplaces.

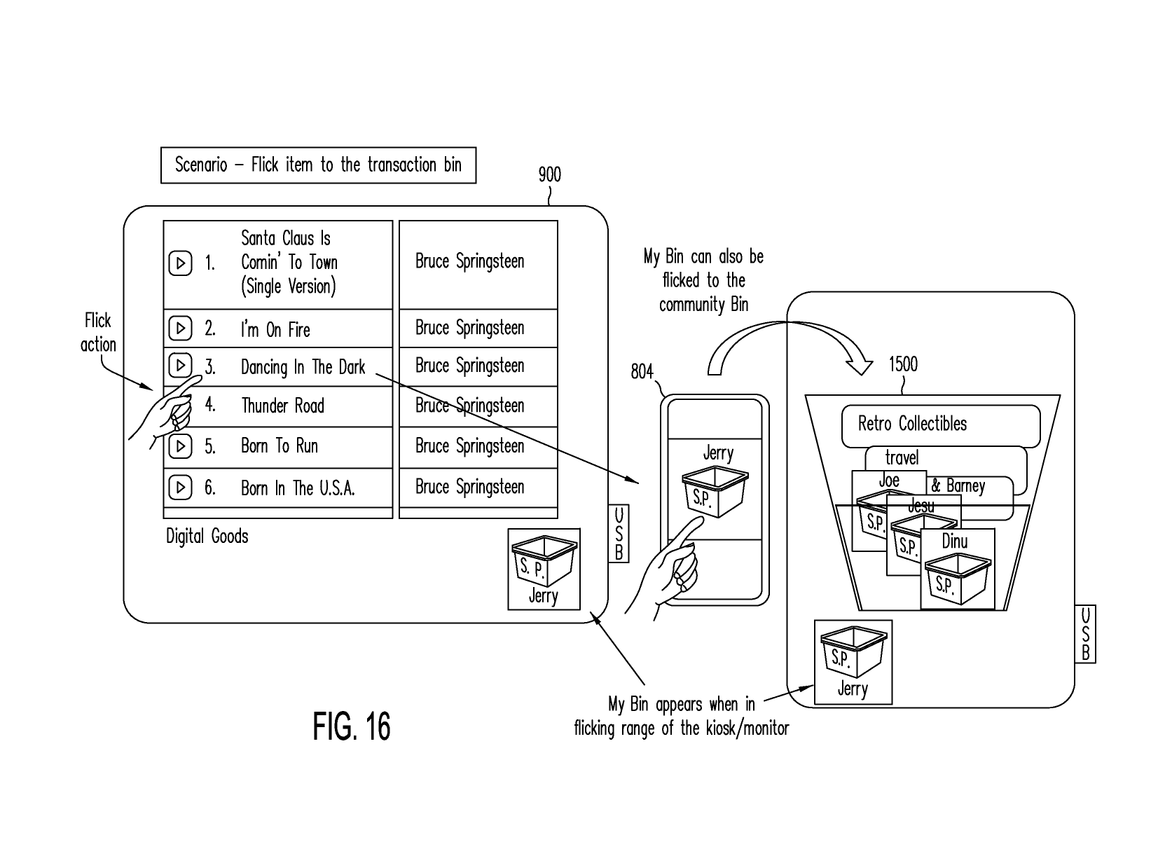

FIG. 16 shows a scenario for using a bin in providing flick transactions as described in the Ser. No. 12/892,234 referenced above. In this case, the transaction bin 206 can reside on the mobile device 804 itself, and the item to be purchased can be flicked to the transaction bin on the handheld mobile device 804 after the handshaking between the sender (kiosk 900 in this case) and the receiver (the mobile device 804). The handshaking protocol is described in the referenced Ser. No. 12/892,234 on flicking. The purchase transaction can be either completed through the sender or through the receiver if the sender is not connected to the Internet and if the receiver is. Flicking can also be used in conjunction with a community bin 1500 (see FIG. 15) as shown in FIG. 16.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A method for performing an electronic transaction, comprising:
receiving transaction information from a user, wherein the information is received in response to the user moving, using a user device, an item displayed on a screen to a bin;
determining item information and merchant information from the transaction information;
determining user information from the bin; and
processing the electronic transaction using the transaction information, the item information, and the user information.

2. The method of claim 1, wherein the screen is on the user device.

3. The method of claim 1, wherein the screen is on another device.

4. The method of claim 1, wherein the bin is displayed on the screen that displays the item.

5. The method of claim 1, wherein the bin is displayed elsewhere than on the screen that displays the item.

6. The method of claim 1, wherein bin includes information about pre-approval conditions for a payment request.

7. The method of claim 1, wherein the bin can be shared with other users.

8. The method of claim 1, wherein the moving is by a drag and drop.

9. The method of claim 1, wherein the bin is movable from device to device.

10. The method of claim 1, wherein the bin includes information comprising user identification, password, credit limit, and merchant information.

11. The method of claim 1, further comprising:
generating a receipt of the transaction; and
providing the receipt through the bin.

12. The method of claim 1, further comprising storing details about the transaction in the bin.

13. The method of claim 1, wherein the bin is one of a plurality of bins to which the user has access via the user device.

14. The method of claim 1, wherein:
the bin is one of a plurality of bins to which the user has access via the user device; and
the bin is available to other users.

15. The method of claim 1, wherein the bin is associated with a user different from the user moving the item.

16. The method of claim 1, wherein the user device comprises a television, a computer, a smart phone, a computing tablet, or a game console.

17. A system comprising a processor and a computer-readable medium having computer readable code for instructing the processor to perform a method, the method comprising:
receiving transaction information from a user, wherein the information is received in response to the user moving, using a user device, an item displayed on a screen to a bin;
determining item information from the transaction information;
determining user information from the bin; and
processing the electronic transaction using the transaction information, the item information, and the user information.

18. The system of claim 17, wherein:
the bin interfaces to an in-app browser executing on the user device via an app running the in-app browser.

19. The system of claim 17, wherein:
the bin interfaces to a browser on the user device via a plug-in to the browser.

20. The system of claim 17, wherein:
the bin is preprogrammed on the server side.

21. The system of claim 17, wherein:
the transaction information includes information derived from a uniform resource locater (URL) or web scraping.

22. A computer program product comprising a non-transitory computer readable medium having computer readable and executable code for instructing a processor to perform a method, the method comprising:
receiving transaction information from a user, wherein the information is received in response to the user moving, using a user device, an item displayed on a screen to a bin;
determining item information from the transaction information;
determining user information from the bin; and
processing the electronic transaction using the transaction information, the item information, and the user information.

23. The computer program product of claim 22, wherein: the transaction information includes a product uniform resource locater (URL) and transaction information retrieved from a merchant product database of a merchant site.
